(19) United States
(12) Patent Application Publication
(10) Pub. No.: US 2021/0146640 A1
(43) Pub. Date: May 20, 2021

(54) PREFORM, TOOLING, AND PROCESS DESIGN FOR COMPONENTS MADE FROM LONG FIBER MATERIALS

(71) Applicant: SAINT-GOBAIN PERFORMANCE PLASTICS CORPORATION, Solon, OH (US)

(72) Inventors: Eugene Gargas, Hinckley, OH (US); Nafih Mekhilef, Shrewsbury, MA (US)

(21) Appl. No.: 17/089,791

(22) Filed: Nov. 5, 2020

Related U.S. Application Data
(60) Provisional application No. 62/935,304, filed on Nov. 14, 2019.

(51) Int. Cl. B29C 70/54; B29C 70/46

(52) U.S. Cl. CPC B29C 70/545; B29K 2077/00; B29C 70/465

(57) ABSTRACT

Systems and methods are disclosed that include forming a molded component by providing a raw material formed from a plurality of fibers disposed in a resin, cutting a plurality of layers of the raw material, placing the plurality of layers in a fixture, heating the plurality of layers in the fixture to form a unitary preform, placing the preform in a molding tool having a plurality of pins and an annular cavity formed between each pin and a cavity plate of the molding tool, and applying heat and pressure to the preform to force a portion of the preform into the annular cavities, wherein the fibers of the portion of the preform forced into the annular cavities are reoriented from a first orientation to a second orientation.

### CROSS-REFERENCE TO RELATED APPLICATION(S)

This application claims priority under 35 U.S.C. § 119(e) to U.S. Provisional Application No. 62/935,304, entitled “PREFORM, TOOLING, AND PROCESS DESIGN FOR COMPONENTS MADE FROM LONG FIBER MATERIALS,” by Eugene GARGAS, filed Nov. 14, 2019, which is assigned to the current assignee hereof and incorporated herein by reference in its entirety.

### BACKGROUND OF THE INVENTION

Traditional fiber-reinforced components made from long-fiber reinforced materials are often produced from a braided long-fiber material having a variety of constructions (e.g., planar, tubular or cylindrical, etc.). Components formed in this manner are often expensive to produce and process-intensive as they involve an individual molding process. The result of this process produces a bearing or bushing having a planar fiber orientation. This planar fiber orientation presents a failure point in the bearing or bushing when the bearing or bushing is subjected to a shear loading condition, often resulting in damage and/or premature failure of the bearing or bushing. As such, more frequent replacement of the bearing or bushing is often required, further increasing the cost, required maintenance, and potential downtime to an end user of such bushings or bearings.

### SUMMARY

Embodiments of the present invention relate in general to a preforming and molding process for forming components, and in particular, to systems and methods of producing a long-fiber polyimide component having improved performance resulting from a transitional fiber orientation between a barrel and a flange of the component that occurs during the molding process.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is an oblique side view of a roll of raw material and a cutting die according to an embodiment of the disclosure.

FIGS. 2A through 2D are cross-sectional views of a portion of the molding tool and the preform during a molding process used to mold the preform into a molded component according to an embodiment of the disclosure.

FIG. 3 is a cross-sectional view of a prior art molded component.

FIGS. 4A and 4B are partial cross-sectional side views of an exemplary embodiment of a molded component.

FIGS. 5A and 5B are partial cross-sectional side views of another exemplary embodiment of a molded component.

FIG. 6 is a flowchart of a method of forming a molded component according to an embodiment of the disclosure.

The use of the same reference symbols in different drawings indicates similar or identical items.

### DETAILED DESCRIPTION

Raw Material Preparation

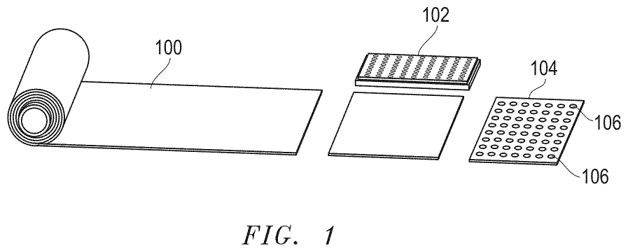

Referring now to FIG. 1, an oblique side view of a roll of raw material 100 and a cutting die 102 are shown according to an embodiment of the disclosure. The raw material 100 generally comprises a plurality of randomly oriented chopped strand fibers (e.g., carbon fibers, glass fibers, aramid fibers, any natural and/or synthetic fibers, or a combination thereof) disposed in a resin binder. The chopped strand fibers may generally comprise a length of at least about 1 millimeter, or even at least about 10 millimeters. In some embodiments, the chopped strand fibers may comprise a length of at least about 10 millimeters to not greater than about 500 millimeters, or even at least about 10 millimeters to not greater than about 110 millimeters. In some embodiments, the resin may comprise a polyimide resin, such as an organic polyimide resin. In some embodiments, the polyimide resin is formed from curing a polyimide precursor after deposition on a substrate. A suitable polyimide precursor can include, for example, poly(amic) acid (PAA). The poly(amic) acid (PAA) can be a reaction product of a monomer mixture containing at least two different monomers. In certain embodiments, the at least two different monomers can be selected from the group consisting of: pyromellitic dianhydride (PMDA), 3,3′-4,4′-biphenyltetracarboxylic dianhydride (BPDA), 2,2-bis (3,4-dicarboxyphenyl) hexafluoropropane dianhydride (6FDA), 2,2′-bis [4-(3,4-dicarboxyphenoxy)phenyl]propane dianhydride (BPADA), benzophenonetetracarboxylic dianhydride (BTDA), and 4,4′-oxydianiline (ODA), or m-phenylene diamine (m-PDA), 4,4′-diaminophenyl sulphone (4,4′-DDS), p-phenylene diamine (p-PDA), and methylene dianiline (MDA). As such, in particular embodiments, the polyimide matrix can be a crosslinked, reaction product of at least two different monomers listed above. In particular embodiments the polyimide matrix may be a pure polyimide matrix. As used herein, the phrase pure polyimide matrix is a polyimide matrix that is essentially free of copolymers with imide monomers. In other words, in certain embodiments, the polyimide matrix can be essentially free of non-imide monomers. Further, the polyamic acid can be derived from a first monomer and a second monomer. The first monomer can be selected from the group consisting of pyromellitic dianhydride (PMDA), 3,3′-4,4′-biphenyltetracarboxylic dianhydride (BPDA), 2,2-bis (3,4-dicarboxyphenyl) hexafluoropropane dianhydride (6FDA), 2,2′-bis [4-(3,4-dicarboxyphenoxy)phenyl]propane dianhydride (BPADA), benzophenonetetracarboxylic dianhydride (BTDA), and any combination thereof. The second monomer can be selected from the group consisting of 4,4′-oxydianiline (ODA), or m-phenylene diamine (m-PDA), 4,4′-diaminophenyl sulphone (4,4′-DDS), p-phenylene diamine (p-PDA), methylene dianiline (MDA), and any combination thereof.

In particular embodiments, the polyimide resin may comprise a PMR-15 type, a DMBZ type, or an AFR 700 or 800 type resin. Additionally, in some embodiments, the polyimide resin may undergo flow after partial or full curing. Still further, in some embodiments, the polyimide resin may be a poly-benzimidazole, a poly-p-Phenylene Benzobisoxazole, or a polybismaldeimide. In alternative embodiments, the polyimide resin may be a product of mono methyl ester, 4,4methylenedianiline (MDA), and diethyl esters of 2,1,3-benzothiadiazole-4,7-dicarboxylic acid (BTDE), or alternatively, a product of mono methyl ester, 2,2-dimethylbenzidine, and diethyl esters of 2,1,3-benzothiadiazole-4,7-dicarboxylic acid (BTDE). However, in other embodiments, the resin may comprise any fluoropolymer, any thermoplastic resin, any thermoset resin, any polymeric resin, any synthetic, natural, or organic resin, or any combination thereof. In particular embodiments, the thermoplastic resin may comprise a fluoropolymer, a perfluoropolymer, PTFE, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI and TPI, or any combination thereof. In other particular embodiments, the thermoset resin may comprise a cyanate ester, an epoxy resin, a polyester thermoset, or any combination thereof.

The raw material 100 may generally be unrolled and cut via a die 102 into a plurality of individual layers 104 of a desired shape. In the embodiment shown, the desired shape is a rectangle. However, in other embodiments, the desired shape may be a circle, oval, square, triangle, trapezoid, or any other shape depending on the shape, size, and desired features of the component being produced from the layers 104 of the raw material 100. Further, the die 102 may also be configured to cut or punch an array of a plurality of holes 106 when each layer 104 is cut from the roll of raw material 100. In some embodiments, the holes 106 may correspond to a central bore of a component being produced. Accordingly, the arrangement, pattern, and size of the holes 106 may be dependent upon the shape, size, and features of the component being produced from the layers 104 of the raw material 100.

Any number of layers 104 may be cut from the roll of raw material 100. When the layers 104 are cut, the die 102 may be rotated between different angular orientations between cuts to provide layers 104 with different fiber orientations in each layer 104. Between cuts may mean between consecutive cuts or between a predetermined number of cuts. In alternative embodiments, the die 102 may be symmetrical (e.g., circle, square, etc.), and the roll of raw material 100 may be rotated with respect to the die 102 instead of rotating the die 102.

Preforming Process

Multiple layers 104 may be stacked in a fixture with pins of the fixture protruding through the holes 106 in each layer 104. The plurality of layers 104 may be placed in the fixture beginning with a first layer 104a₁ and ending with the final layer 104aₙ, where “n” represents the total number of layers 104. In some embodiments, consecutive layers 104 stacked in the fixture may comprise substantially alternating and/or different fiber orientations.

The total number of layers 104 may generally be determined based on a desired shot weight or thickness of the molded component. In some embodiments, the layers 104 may comprise a thickness of at least about 0.02 millimeters to not greater than about 50 millimeters. However, in other embodiments, the layers 104 may comprise any other thickness depending on the type of fibers and resin used in the raw material 100. In some embodiments, the total number of layers 104 may be 3, 4, 5, 6, 7, 8, 9, 10, or more. In some embodiments, the total number of layers 104 may be at least 3, at least 4, at least 5, at least 6, at least 7, at least 8, at least 9, at least 10, at least 15, at least 20, at least 50, or at least 100. Additionally, in some embodiments, the total number of layers 104 may not be greater than 1000, not greater than 500, not greater than 100, not greater than 50, not greater than 10, not greater than 9, not greater than 8, or not greater than 7. Furthermore, it will be appreciated that the total number of layers 104 may be in a range between any of the preceding minimum and maximum values.

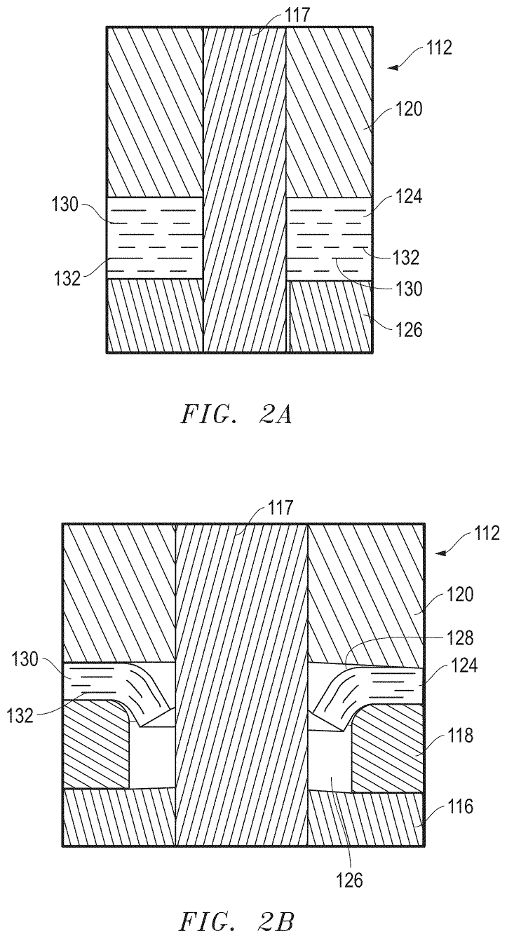

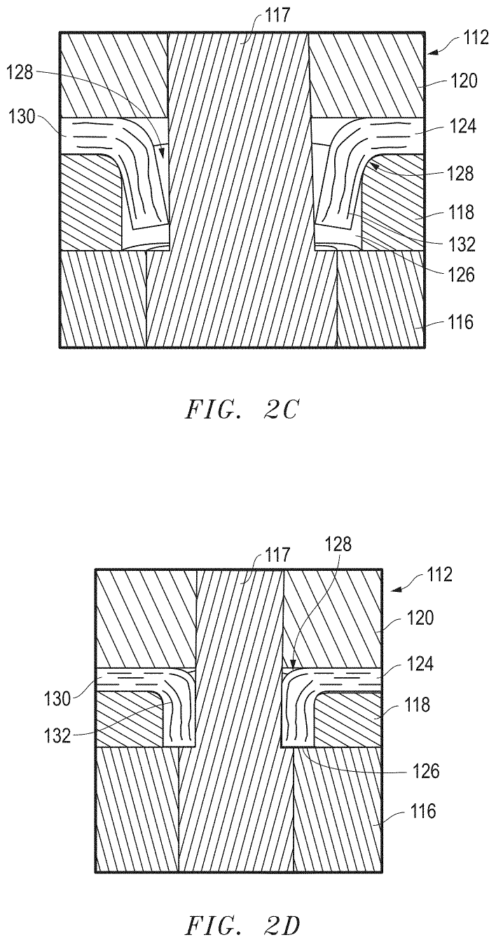

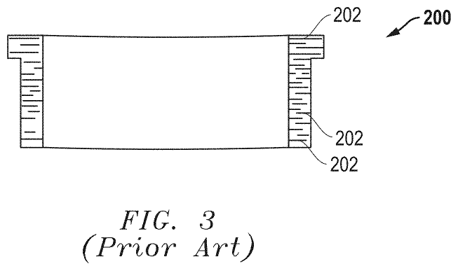

Once all of the layers 104 are stacked in the fixture, the layers 104 of raw material 100 in the fixture may be subjected to a curing process at a temperature of at least about 150 degrees Fahrenheit to not greater than about 500 degrees Fahrenheit. The fixture may be subjected to a curing temperature for a predetermined amount of time. Once the curing process is complete, the fixture may be removed from the oven and allowed to cool. The curing process forms a unitary “preform” from the plurality of layers 104 of raw material 100. Once cooled, the unitary preform 124 (shown in FIGS. 2A through 2D) may be removed from the fixture.

Molding Cycle

As shown in FIGS. 2A through 2D, a molding tool 112 may generally be used in molding the preform 124 into a molded component. In some embodiments, the molding tool 112 may comprise a main body having a base plate and a plurality of pins 117 extending through the base plate, a cavity plate 118 having a plurality of holes that align with the plurality of pins 117, and a punch block 120 having a plurality of holes that align with the plurality of pins 117 and the holes in the cavity plate 118.When the preform 124 is ready for molding, the molding tool 112 may be prepared to receive the preform 124. Once the molding tool 112 is prepared for molding, the preform 124 may be placed in the molding tool 112 on top of the cavity plate 118, such that the pins 117 of the molding tool 112 protrude through the holes 106 of the preform 124 and the preform 124 is substantially flush with the cavity plate 118. The punch block 120 may then be placed in the molding tool 112 on top of the preform 124, and a punch that drives the punch block 120 may then be cycled to close the molding tool 112 and begin the molding process.

During the molding process, the preform 124 may be subjected to a molding cycle at one or more molding temperatures (e.g., at least about 125 degrees Celsius to not greater than 425 degrees Celsius) for a predetermined time period (e.g., at least about 10 seconds to not greater than 5 minutes, such as at least about 20 seconds to not greater than 120 seconds). In some embodiments, the molding cycle may comprise a temperature and pressure profile that may result in at least partial or complete cross-linking of the polymers of the raw material 100 in the preform 124. In some embodiments, the temperature and pressure profile may comprise increasing the temperature and/or pressure over a predetermined period of time or predetermined number of cycles to complete the molding process. For example, in some embodiments, the molding cycle may comprise increasing the temperature by at least about 1 degree Celsius, such as at least about 5 degrees Celsius, or at least about 10 degrees Celsius, for a predetermined period of time, such as at least about 10 seconds to not greater than about 5 minutes. In some embodiments, the pressure applied to the preform 124 during the molding process may be at least about 3.45 MPa to not greater than about 68.95 MPa. It will be appreciated that the pressure applied to the preform 124 may be proportional to forming a molded component having a longer molded barrel or a thinner molded wall.

FIGS. 2A through 2D show cross-sectional views of a portion of the molding tool 112 and the preform 124 during the molding process according to an embodiment of the disclosure. As shown in FIG. 2A, the preform 124 has been placed into the molding tool 112 with the punch block 120 substantially in contact with the preform 124. Resin 130 may be in a substantially solid form, and fibers 132 disposed in the resin 130 may comprise a substantially horizontal, planar, or uniform orientation. With the preform 124 in a substantially solid form, annular cavities 126 formed between the holes in the cavity plate 118 and circumferentially about the pins 117 may be vacant when the preform 124 is placed into the molding tool 112.

During the molding process, heat is applied to the preform 124 according to at least one temperature and pressure profile discussed herein. When heat is applied to the preform 124 during the molding process, the resin 130 may begin to at least partially melt. As shown in FIG. 2B, when pressure is first applied to the heated preform 124, the resin 130 and fibers 132 flow under temperature and pressure into the annular cavities 126, and the fibers 132 in the transition region 128 may “dive” into the annular cavities 126 with the flow of the resin 130, causing the fibers 132 in the transition region 128 to at least partially reorient. In some embodiments, the fibers 132 in the transition region 128 may reorient from their initial substantially horizontal, planar, or uniform orientation by at least 5 degrees, at least 10 degrees, at least 15 degrees, at least 20 degrees, at least 25 degrees, at least 30 degrees, at least 35 degrees, at least 45 degrees, at least 60 degrees, or at least 75 degrees.

As shown in FIG. 2C, as pressure is continually applied and/or the temperature is increased, the resin 130 and fibers 132 of the preform 124 may be continually forced deeper into the annular cavities 126. The fibers 132 may continue to “dive” further into the annular cavities 126 with the flow of the resin 130, thereby further reorienting additional fibers 132 that are forced into the annular cavities 128, until the annular cavities 126 are substantially, or completely, filled by the resin 130 and the fibers 132. As shown in FIG. 2D, the annular cavities 126 have been substantially, or completely, filled by the resin 130 and the fibers 132. As such, it will be appreciated that the fibers 132 forced at least partially into the annular cavities 126 may be reoriented from their initial substantially horizontal, planar, or uniform orientation by at least 5 degrees, at least 10 degrees, at least 15 degrees, at least 20 degrees, at least 25 degrees, at least 30 degrees, at least 35 degrees, at least 45 degrees, at least 60 degrees, or at least 75 degrees. In some embodiments, at least a portion of the reoriented fibers 132 may be substantially perpendicular to other fibers 132 (substantially parallel to pins 117 or a central axis of pins 117) that were not reoriented and remain in their initial substantially horizontal, planar, or uniform orientation. Since some fibers 132 are forced further into the annular cavities 126 than others, it will be appreciated that fibers 132 forced at least partially into the annular cavities 126 may comprise a wide range of reorientations.

De-Molding Process

Once the molding process is completed, the molding tool 112 may be disassembled to retrieve the molded preform. The molded preform generally represents a sheet of connected molded components, which may then be individually cut, milled, punched, or otherwise separated.

Cutting Process

After the molded preform is removed from the molding tool 112, a plurality of molded components may be cut, milled, punched, or otherwise separated from the molded preform. In some embodiments, the resin 130 and the fibers 132 forced into the annular cavities 126 form barrels of a plurality of bushings or bearings, while the remainder of the molded preform represents connected flange portions of the plurality of the bushings or bearings. Accordingly, individual flanges may be radially cut, milled, punched, or otherwise separated from the flange portion of the molded preform to form a plurality of individual bushings or bearings. It will be appreciated that the molding process disclosed herein provides for the bulk creation of flanged bushing or bearings, where multiple bushings or bearings may be molded at once and then cut, milled, punched, or otherwise separated after molding. Alternatively, in other embodiments, the molding process disclosed herein may be used to form other components, including but not limited to aircraft or automotive components, brackets, lightweight sheet panels, tools, and/or any other molded components, and this disclosure is not intended to be limited to the exemplary embodiments of a bushing or bearing.

### EXAMPLES

Referring now to FIG. 3, a cross-sectional view of a prior art molded component 200 is shown. As shown in FIG. 3, prior art molded component comprises fibers having a substantially planar orientation through a barrel and a flange of the component.

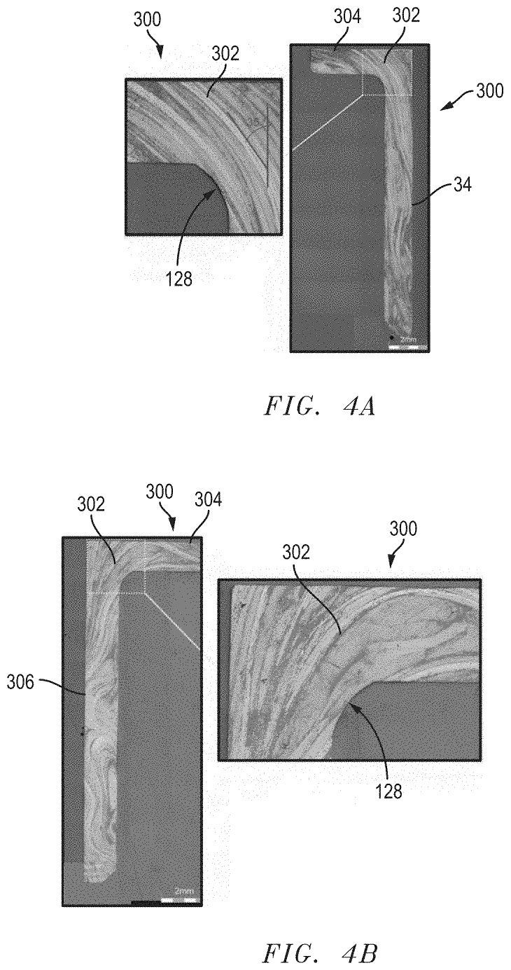

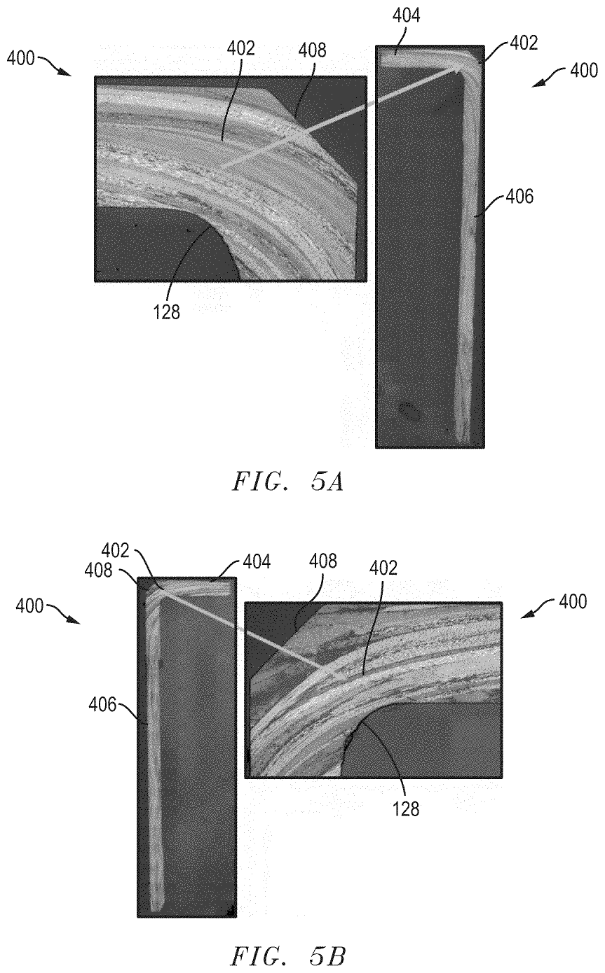

Referring now to FIGS. 4A through 5B, partial cross-sectional side views of an exemplary embodiment of a molded component 300, and partial cross-sectional side views of another exemplary embodiment of a molded component 400 are shown according to embodiments of the disclosure. As shown in FIGS. 4A and 4B, fibers 302 that form the molded component 300 have been reoriented through the molding process disclosed herein. In the embodiment shown, at least a portion of the fibers 302 in the transition region 128 have been reoriented by about 35 degrees, the transition region 128 being the region where the barrel 304 and the flange 306 of the molded component 300 join. In alternative embodiments, the barrel may be item 306, and the flange may be item 304. As shown in FIGS. 5A and 5B, fibers 402 that form the molded component 400 have been reoriented through the molding process disclosed herein. In the embodiment shown, at least a portion of the fibers 402 in the transition region 128 have been reoriented beyond 45 degrees, the transition region 128 again being the region where the barrel 404 and the flange 406 of the molded component 400 join. Further, molded component 400 also comprises a chamfered corner 408. However, in other embodiments, molded components 300, 400 may comprise rounded corners, and/or a chamfered or rounded underside that may comprise a complementary angle or radius, respectively, in order to maintain a uniform thickness of the molded component 300, 400.

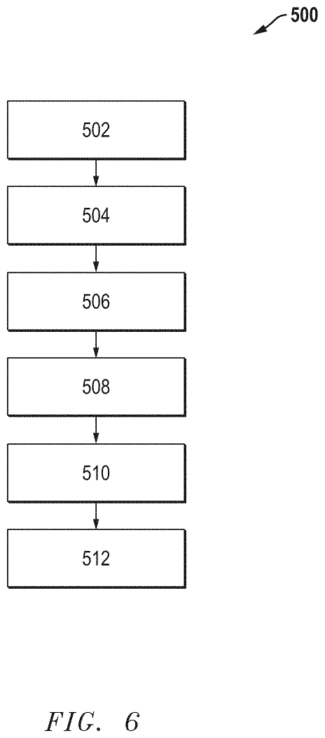

Referring now to FIG. 6, a flowchart of a method 500 of forming a molded component is shown according to an embodiment of the disclosure. Method 500 may begin at block 502 by providing a raw material 100 formed from a plurality of fibers 132 disposed in a resin 130. Method 500 may continue at block 504 by cutting a plurality of layers 104 from the raw material 100. Additionally, cutting the layers 104 may also involve cutting a plurality of holes 106 in each layer 104. Method 500 may continue at block 506 by placing the plurality of layers 104 in a fixture. In some embodiments, consecutive layers 104 stacked in the fixture may comprise substantially alternating and/or different fiber orientations. Method 500 may continue at block 508 by heating the plurality of layers 104 in the fixture to form a unitary preform 124. Method 500 may continue at block 510 by placing the preform 124 in a molding tool 112 having a plurality of pins 117 and an annular cavity 126 formed between each pin 117 and holes in a cavity plate 118 of the molding tool 112. Method 500 may conclude at block 512 by applying heat and pressure to the preform 124 to force a portion of the preform 124 into the annular cavities 126, wherein the fibers 132 of the portion of the preform 124 forced into the annular cavities 126 are reoriented from a first orientation to a second orientation. In some embodiments, method 500 may also comprise removing the molded preform from the molding tool 112, and/or cutting a plurality of molded components 300, 400 from the molded preform. In some embodiments, the resin 130 and the fibers 132 forced into the annular cavities 126 form barrels of a plurality of bushings or bearings, while the remainder of the molded preform represents connected flange portions of the plurality of the bushings or bearings. Accordingly, individual flanges may be radially cut, milled, punched, or otherwise separated from the flange portion of the molded preform to form a plurality of individual bushings or bearings.

In still other embodiments, the method may include one or more of the following embodiments:

Embodiment 1. A method of forming a component, comprising: providing a preform comprised of a plurality of fibers disposed in a resin; placing the preform into a molding tool; and applying heat and pressure to the preform to force at least a portion of the preform into an annular cavity of the molding tool, wherein the fibers of the portion of the preform forced into the annular cavity are reoriented from a first orientation to a second orientation.

Embodiment 2. The method of embodiment 1, wherein the resin comprises a thermoplastic resin or thermoset resin.

Embodiment 3. The method of embodiment 2, wherein the thermoplastic resin comprises a fluoropolymer, a perfluoropolymer, PTFE, PVF, PVDF, PCTFE, PFA, FEP, ETFE, ECTFE, PCTFE, a polyarylketone such as PEEK, PEK, or PEKK, a polysulfone such as PPS, PPSU, PSU, PPE, or PPO, aromatic polyamides such as PPA, thermoplastic polyimides such as PEI and TPI, or any combination thereof.

Embodiment 4. The method of embodiment 2, wherein the thermoset resin comprises a cyanate ester, an epoxy resin, a polyester thermoset, or any combination thereof.

Embodiment 5. The method of embodiment 2, wherein the resin comprises a polyimide resin.

Embodiment 6. The method of embodiment 5, wherein the polyimide resin is formed from curing a polyimide precursor after deposition on a substrate.

Embodiment 7. The method of embodiment 5, wherein the polyimide resin comprises a PMR-15 type, a DMBZ type, or an AFR 700 or 800 type.

Embodiment 8. The method of embodiment 5, wherein the polyimide resin undergoes flow after partial or full curing.

Embodiment 9. The method of embodiment 5, wherein the resin is an organic polyimide resin.

Embodiment 10. The method of embodiment 5, wherein the polyimide resin is a poly-benzimidazole, a poly-p-Phenylene Benzobisoxazole, or a polybismaldeimide.

Embodiment 11. The method of embodiment 5, wherein the polyimide resin is a product of mono methyl ester, 4,4methylenedianiline (MDA), and diethyl esters of 2,1,3-benzothiadiazole-4,7-dicarboxylic acid (BTDE).

Embodiment 12. The method of embodiment 5, wherein the polyimide resin is a product of mono methyl ester, 2,2-dimethylbenzidine, and diethyl esters of 2,1,3-benzothiadiazole-4,7-dicarboxylic acid (BTDE).

Embodiment 13. The method of embodiment 1, wherein the plurality of fibers comprises carbon fibers, glass fibers, aramid fibers, natural or synthetic fibers, or a combination thereof.

Embodiment 14. The method of embodiment 1, wherein the preform is formed from a plurality of layers.

Embodiment 15. The method of embodiment 14, wherein the plurality of layers comprise a thermoplastic uniaxial tape or thermoplastic layers intercalated with long or short fibers between the thermoplastic layers.

Embodiment 16. The method of embodiment 14, further comprising: cutting the plurality of layers.

Embodiment 17. The method of embodiment 16, wherein cutting the plurality of layers further comprises punching an array of holes in each of the plurality of layers.

Embodiment 18. The method of any of embodiments 14-17, further comprising: stacking the layers in a fixture, wherein consecutive layers are stacked in the fixture at different cut orientations.

Embodiment 19. The method of embodiment 18, further comprising: subjecting the plurality of stacked layers in the fixture to a curing process to form the preform.

Embodiment 20. The method of embodiment 1 or 19, further comprising: applying pressure and heat to the preform.

Embodiment 21. The method of embodiment 20, wherein applying the heat to the preform causes the resin to at least partially melt, and wherein applying pressure to the preform forces at least a portion of the fibers and the at least partially melted resin into annular cavities of the molding tool.

Embodiment 22. The method of embodiment 21, wherein the portion of the fibers forced into the annular cavities is reoriented from the first orientation to the second orientation.

Embodiment 23. The method of embodiment 22, wherein at least a portion of fibers forced into the annular cavities are reoriented by at least 5 degrees, at least 10 degrees, at least 15 degrees, at least 20 degrees, at least 25 degrees, at least 30 degrees, at least 45 degrees, at least 60 degrees, at least 75 degrees, or at least 90 degrees from the first orientation to the second orientation.

Embodiment 24. The method of embodiment 23, further comprising: removing the preform from the molding tool; and cutting a plurality of components from the preform.

Embodiment 25. The method of embodiment 24, wherein cutting the plurality of components from the preform requires radially cutting out a flange of each of a plurality of bushings or bearings.

Embodiment 26. The method of embodiment 25, wherein each of the plurality of bushings or bearings comprises a barrel extending axially from the flange of each of the plurality of bushings or bearings.

Embodiment 27. The method of embodiment 26, wherein each of the plurality of bushings or bearings comprises a transition region from between the flange and the barrel.

Embodiment 28. The method of embodiment 27, wherein the fibers in the transition region are reoriented by at least 5 degrees, at least 10 degrees, at least 15 degrees, at least 20 degrees, at least 25 degrees, at least 30 degrees, at least 45 degrees, at least 60 degrees, or at least 75 degrees from the first orientation to the second orientation.

Embodiment 29. The method of embodiment 1, wherein the component comprises a flange and a barrel extending axially from the flange, wherein the barrel of the component is formed in the annular cavity.

Embodiment 30. A method of forming a component, the method comprising: providing a raw material formed from a plurality of fibers disposed in a resin; cutting a plurality of layers of the raw material; placing the plurality of layers in a fixture; heating the plurality of layers in the fixture to form a unitary preform; placing the preform in a molding tool having a plurality of pins and an annular cavity formed between each pin and a cavity plate of the molding tool; and applying heat and pressure to the preform to force a portion of the preform into the annular cavities, wherein the fibers of the portion of the preform forced into the annular cavities are reoriented from a first orientation to a second orientation.

Embodiment 31. The method of embodiment 30, wherein the resin comprises a thermoplastic resin.

Embodiment 32. The method of embodiment 31, wherein the resin comprises a polyimide resin.

Embodiment 33. The method of embodiment 32, wherein the resin is an organic polyimide resin.

Embodiment 34. The method of embodiment 30, wherein the plurality of fibers comprises carbon fibers, glass fibers, aramid fibers, natural or synthetic fibers, or a combination thereof.

Embodiment 35. The method of any of embodiments 30-34, further comprising: stacking the layers in a fixture, wherein consecutive layers are stacked in the fixture at different cut orientations.

Embodiment 36. The method of embodiment 35, further comprising: subjecting the plurality of stacked layers in the fixture to a curing process to form the preform.

Embodiment 37. The method of embodiment 30 or 36, further comprising: applying heat and pressure to the preform.

Embodiment 38. The method of embodiment 37, wherein applying the heat to the preform causes the resin to at least partially melt, and wherein applying pressure to the preform forces at least a portion of the fibers and the at least partially melted resin into the annular cavities of the molding tool.

Embodiment 39. The method of embodiment 38, wherein the fibers forced into the annular cavities are reoriented from the first orientation to the second orientation.

Embodiment 40. The method of embodiment 39, wherein at least a portion of the fibers forced into the annular cavities are reoriented by at least 5 degrees, at least 10 degrees, at least 15 degrees, at least 20 degrees, at least 25 degrees, at least 30 degrees, at least 45 degrees, at least 60 degrees, at least 75, or at least 90 degrees from the first orientation to the second orientation.

Embodiment 41. The method of embodiment 40, further comprising: removing the preform from the molding tool; and cutting a plurality of components from the preform.

Embodiment 42. The method of embodiment 41, wherein cutting the plurality of components from the preform requires radially cutting out a flange of each of a plurality of bushings or bearings.

Embodiment 43. The method of embodiment 42, wherein the first feature comprises a barrel extending axially from the flange of each of the plurality of bushings or bearings.

Embodiment 44. The method of embodiment 43, wherein each of the plurality of bushings or bearings comprises a transition region between the flange and the barrel.

Embodiment 45. The method of embodiment 44, wherein the fibers in the transition region are reoriented by at least 5 degrees, at least 10 degrees, at least 15 degrees, at least 20 degrees, at least 25 degrees, at least 30 degrees, at least 45 degrees, at least 60 degrees, or at least 75 degrees from the first orientation to the second orientation.

Embodiment 46. The method of embodiment 23, 40, or 45, wherein the annular cavities each comprise a first portion and a second portion, wherein when the preform is placed into the molding tool the second portions are vacant and the preform occupies the first portions, and wherein applying pressure to at least a portion of the preform with the punch block of the molding tool forces at least a portion of the fibers and the at least partially melted resin into the second portions.

This written description uses examples to disclose the embodiments, including the best mode, and also to enable those of ordinary skill in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method of forming a component, comprising:
providing a preform comprised of a plurality of fibers disposed in a resin;
placing the preform into a molding tool; and
applying heat and pressure to the preform to force at least a portion of the preform into at least one annular cavity of the molding tool, wherein the fibers of the portion of the preform forced into the at least one annular cavity are reoriented from a first orientation to a second orientation.

2. The method of claim 1, wherein the resin comprises a thermoplastic resin or thermoset resin.

3. The method of claim 2, wherein the resin comprises a polyimide resin.

4. The method of claim 3, wherein the polyimide resin comprises an organic polyimide resin, a PMR-15 type, a DMBZ type, an AFR 700 or 800 type resin, a poly-benzimidazole, a poly-p-Phenylene Benzobisoxazole, a polybismaldeimide, a product of mono methyl ester, 4,4 methylenedianiline (MDA), and diethyl esters of 2,1,3-benzothiadiazole-4,7-dicarboxylic acid (BTDE), or a product of mono methyl ester, 2,2-dimethylbenzidine, and diethyl esters of 2,1,3-benzothiadiazole-4,7-dicarboxylic acid (BTDE).

5. The method of claim 1, wherein the plurality of fibers comprises carbon fibers, glass fibers, aramid fibers, natural or synthetic fibers, or a combination thereof.

6. The method of claim 1, wherein the preform is formed from a plurality of layers.

7. The method of claim 6, further comprising: cutting the plurality of layers.

8. The method of claim 7, wherein cutting the plurality of layers further comprises punching an array of holes in each of the plurality of layers.

9. The method of claim 8, further comprising: stacking the layers in a fixture, wherein consecutive layers are stacked in the fixture at different orientations.

10. The method of claim 9, further comprising: subjecting the plurality of stacked layers in the fixture to a curing process to form the preform.

11. The method of claim 1, further comprising: applying heat and pressure to the preform, wherein applying the heat to the preform causes the resin to at least partially melt, and wherein applying pressure to the preform forces at least a portion of the fibers and at least a portion of the at least partially melted resin into the at least one annular cavity of the molding tool.

12. The method of claim 11, wherein the portion of the fibers forced into the at least one annular cavity is reoriented from the first orientation to the second orientation.

13. The method of claim 12, wherein at least a portion of fibers forced into the at least one annular cavity is reoriented by at least 5 degrees, at least 10 degrees, at least 15 degrees, at least 20 degrees, at least 25 degrees, at least 30 degrees, at least 45 degrees, at least 60 degrees, at least 75 degrees, or at least 90 degrees from the first orientation to the second orientation.

14. The method of claim 1, further comprising: removing the preform from the molding tool; and cutting at least one component from the preform.

15. The method of claim 14, wherein cutting the at least one component from the preform requires radially cutting out a flange of at least one bushing or bearing.

16. The method of claim 15, wherein the at least one bushing or bearing comprises a barrel extending axially from the flange of the at least one bushing or bearing, and wherein the barrel of the at least one bushing or bearing is formed in the at least one annular cavity.

17. The method of claim 16, wherein the at least one bushing or bearing comprises a transition region between the flange and the barrel.

18. The method of claim 17, wherein the fibers in the transition region are reoriented by at least 5 degrees, at least 10 degrees, at least 15 degrees, at least 20 degrees, at least 25 degrees, at least 30 degrees, at least 45 degrees, at least 60 degrees, or at least 75 degrees from the first orientation to the second orientation.

19. The method of claim 1, further comprising: removing the preform from the molding tool;
and cutting a plurality of components from the preform.

20. The method of claim 19, wherein cutting the plurality of components from the preform requires radially cutting out a flange of each of a plurality of bushings or bearings, wherein each of the plurality of bushings or bearings comprises a barrel extending axially from a flange of the at least one bushing or bearing, and wherein the barrel of each of the plurality of bushings or bearings is formed in one of a plurality of annular cavities.
